(19) United States
(12) Patent Application Publication
(10) Pub. No.: US 2026/0124104 A1
(43) Pub. Date: May 7, 2026

(54) MASSAGE MODULE AND MASSAGE DEVICE

(71) Applicant: Shenzhen Zhonghongtian Technology Co., Ltd., Shenzhen (CN)

(72) Inventors: Bowen Zhu, Shenzhen (CN); Hong Zhang, Shenzhen (CN)

(21) Appl. No.: 19/027,418

(22) Filed: Jan. 17, 2025

(30) Foreign Application Priority Data
Nov. 5, 2024 (CN) 202422695529.1
Jan. 13, 2025 (CN) 202520076879.1

(51) Int. Cl. A61H 19/00; A61H 7/00

(52) U.S. Cl. CPC A61H 19/44; A61H 7/005; A61H 19/34; A61H 2201/0153; A61H 2201/123; A61H 2201/1695

(57) ABSTRACT

A massage module, comprising: a housing comprising a handle portion and defining a massage area, at least one opening extending along an extending direction, wherein a predetermined inclination angle is defined between the extending direction and a longitudinal axis direction of at least a portion of the housing corresponding to the massage area; a driving mechanism located in the housing, and a massage member driven by the driving mechanism, the massage member comprising a first portion coupled to the driving mechanism and driven by the driving mechanism; and at least one second portion un-slidably mounted on the first portion, the at least one second portion is extendable through the at least one opening and extending to the external space to contact the to-be-massaged member, wherein the at least one second portion is movable relative to the housing along the at least one opening.

### CROSS-REFERENCE TO RELATED APPLICATIONS

This application claims the benefit of priority to Chinese Patent Application Number 202422695529.1 filed on Nov. 5, 2024 and Chinese Patent Application Number 202520076879.1 filed on Jan. 13, 2025, in the China National Intellectual Property Administration. The entire contents of the above-identified application are hereby incorporated by reference.

### TECHNICAL FIELD

This present disclosure relates to a massage module and a massage device for massaging a part of a human body (including but not limited to body cavity, such as vagina).

### BACKGROUND

Massage is a kind of way to achieve health care, pleasure and stimulation by directly or indirectly stimulating on an object. Massage devices are widely popular among consumers. In a traditional massage device, a vibration motor is usually set in the massage device. The motor drives an inertial eccentric wheel to rotate, thereby driving a shell of the massage device to vibrate so as to massage an object. However, the vibrations by the cooperation of the vibration motor and the inertial eccentric wheel may be not strong enough to achieve a wanted massage effect. Especially, when the massage device is used for a body cavity, a massage device having a strong massage effect is required.

### BRIEF DESCRIPTION OF DRAWINGS

Embodiments of the present disclosure will now be described, by way of embodiment, with reference to the attached figures. The structure, operation, and advantages of the present invention will become further apparent upon consideration of the following description taken in conjunction with the accompanying figures. The figures are intended to be illustrative, and not limiting.

FIG. 1 is a perspective view of an embodiment of a massage module.

FIG. 2 is a cross-section view of an internal structure of the massage module.

FIG. 3A is a view showing protrusions of the massage module, the protrusions are located at first positions.

FIG. 3B is a view showing the protrusions located at a second position.

FIG. 4 is a perspective view of a first application example of the massage module.

FIG. 5 is a cross-section of the massage device shown in FIG. 4 along a VI-VI line.

FIG. 6 is an exploded view of the massage device shown in FIG. 4.

FIG. 7 is a perspective view of a second application example of the massage module.

FIG. 8 is a perspective view of a third application example of the massage module.

FIG. 9 is a schematic diagram of one of variation examples of the massage module.

FIG. 10 is a schematic diagram of another variation example of the massage module.

### DETAILED DESCRIPTION

The following will be combined with the drawings in the embodiments of the present application to clearly and completely describe the technical solutions in the embodiments of the present application. Obviously, the described embodiments are only part of the embodiments of the present application, not all of the embodiments. Based on the embodiments in the present application, all other embodiments obtained by ordinary technicians in this field without creative work are within the scope of protection of this application.

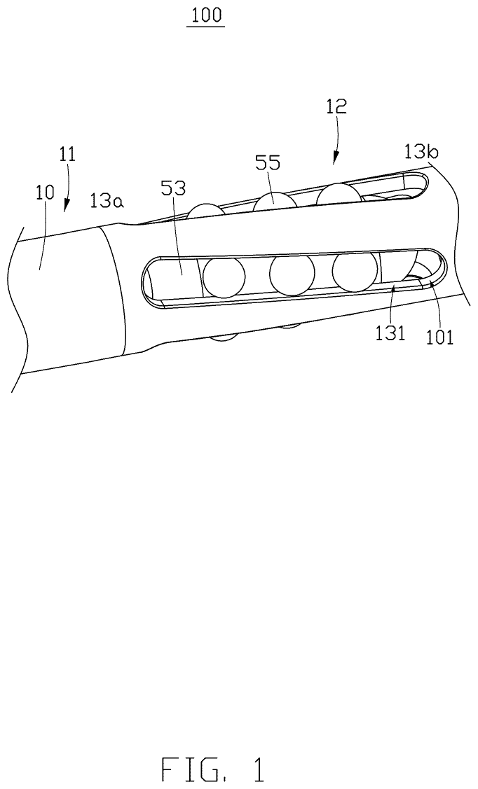

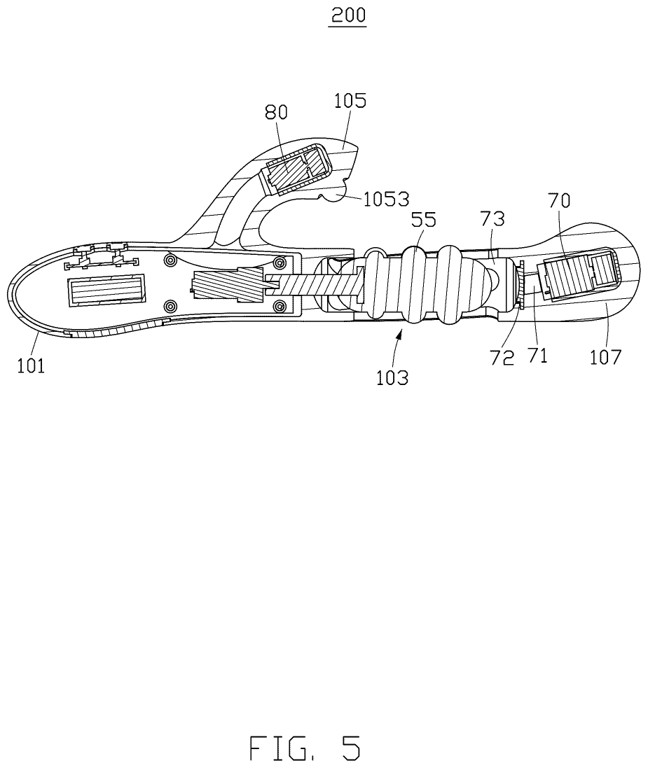

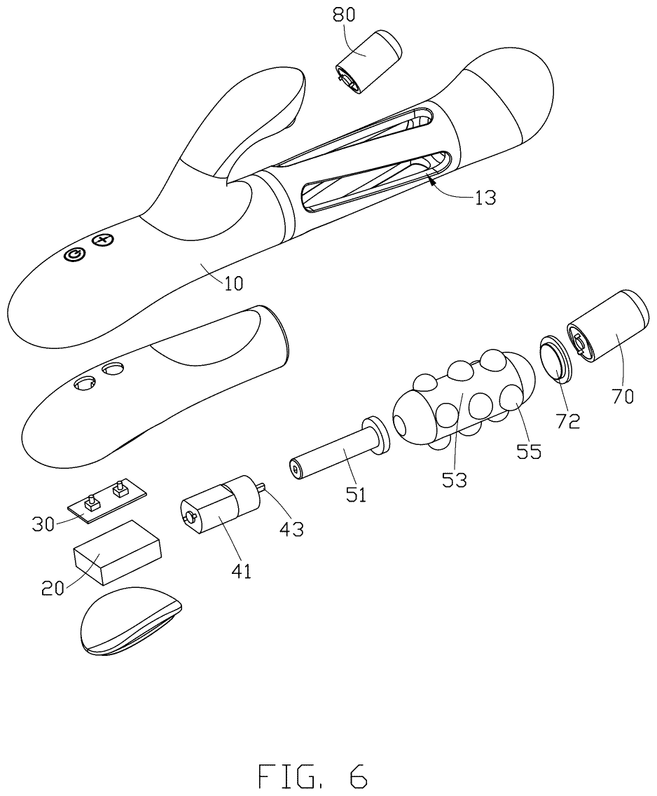

The specific implementation of the present application is further described in detail below with reference to FIG. 1 to FIG. 10.

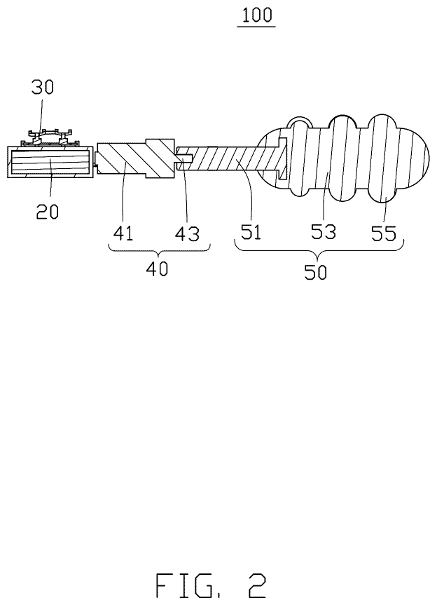

Referring to FIG. 1 and FIG. 2, a massage module 100 of the present disclosure includes a housing 10, a battery 20, a control circuit board 30, a driving mechanism 40 and a massage member 50. The housing 10 includes a handle portion 11 for held by a user and a massage portion 12 which defines a massage area (also labeled as 12) for providing a massage function at the massage area. The battery 20, the control circuit board 30 and the driving mechanism 40 are installed in the housing 10, and are correspondingly installed in the handle area 11. The battery 20 is used for providing power to the control circuit board 30 and the driving mechanism 40. The control circuit board 30 is electrically coupled to the driving mechanism 40, so as to control an operation of the driving mechanism 40. The massage member 50 can be movably installed in the massage portion 12 of the housing 10. One end of the massage member 50 is connected to the driving mechanism 40, and a part of the massage member 50 protrudes from the housing 10 to the exterior of the massage module 100 for contacting a to-be-massaged member. When the massage module is power on, under the control of the control circuit board 30, the drive of the driving mechanism 40 drives the part of the massage member 50 protruding from the housing 10 slides relative to the housing 10 along a direction overlapped or parallel to a longitudinal axis L of the housing 10, thereby achieving the massaging function on the to-be-massage member.

The housing 10 may be include a hollow column structure. The housing 10 defines a first inner space in the handle portion 11 so as to accommodate the battery 20, the control circuit board 30 and the driving mechanism 40. The housing 10 defines a second inner space 101 in the massage portion 12 so as to accommodate the massage member 50, and allowing the massage member 50 be movable in the second inner space 101. The massage portion 12 includes a side wall which surrounds the second inner space and defines the second inner space 101. A plurality of strip-shaped openings 13 are defined in the side wall in the massage area. Each opening 13 extends from an end adjacent to the handle portion 10 toward an end away from the handle portion 11. The second space 101 is air communicated with the exterior through the plurality of strip-shaped openings 13. The massage member 50 is thus capable of partly protruding to the exterior through the openings 13. The plurality of openings 13 may be arranged surrounding a circle of the sidewall with being parallel to each other and spaced apart from each other. The openings 13 may obliquely extend with a same predetermined inclination angle θ relative to the longitudinal axis direction L of the housing 10. A preferred range for the oblique angle θ is in a range of 0 to 45 degrees.

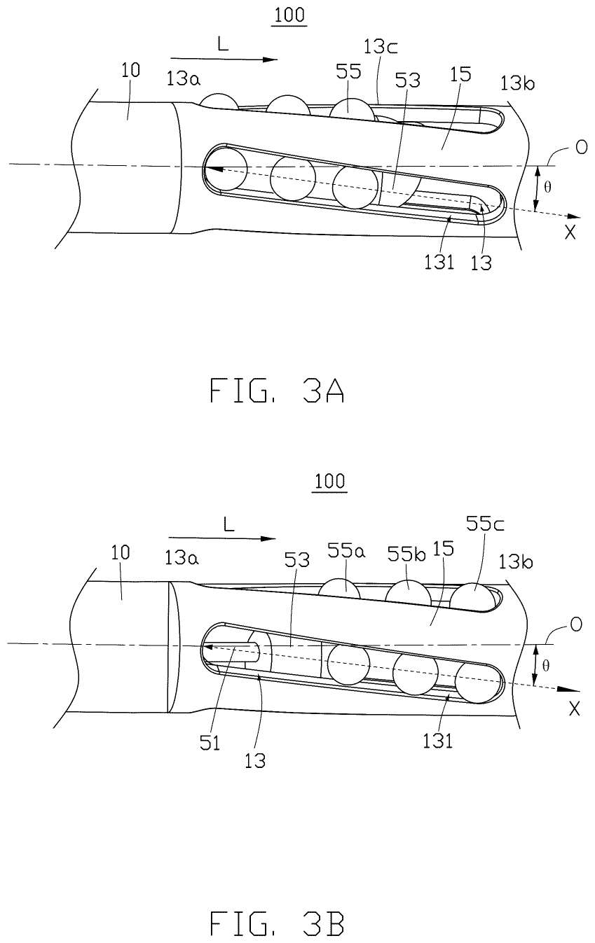

Please also refer to FIG. 3, each opening 13 includes a proximal end 13a adjacent to the handle portion 11, a distal end 13b opposite to the proximal end 13a and away from the handle portion 11, and a connecting portion 13c air communicates with the proximal end 13a and the distal end 13b. The opening 13 is extended from the proximal end 13a, the connecting portion 13c to the distal end 13b, thereby defining an extending trajectory line X. In one embodiment, the extending trajectory line X intersects with a central axis O of the massage module 100. An intersection angle θ is defined by the extending trajectory line X and the central axis O. The proximal end 13a and the distal end 13b are at least partially offset in a first direction, a second direction, and a third direction. The first direction is parallel to the central axis O of the housing 10, the second direction is perpendicular to the first direction, and the third direction is perpendicular to both of the first and second directions. In other words, the proximal end 13a and the distal end 13b of each strip-shaped opening 13 are not on a same horizontal plane. The connecting portion 13c of the opening 13 includes two guide surfaces 131 disposed opposite to each other. The guide surfaces 131 is configured for defining a move path of the massage member 50 and guiding the movement of the massage member 50.

In one embodiment, the housing 10 is provided with at least two strip-shaped openings 13, which are arranged with equal intervals, and an opening width of each opening 13 is the same. In other embodiments of the present disclosure, the massage member is exposed to the exterior only from a half shell of the housing 10, such as an upper shell. Accordingly, the at least two openings 13 are entirely defined in the half shell. A partition wall 15 is formed between each two openings 13. At least one of the openings 13 can be a narrow, straight opening with arc-shaped ends.

As shown in FIG. 1, the openings 13 are in the shape of long strips. There are four openings 13, which are arranged substantially around the circumference of the side wall of the housing 10 at equal intervals in the circumferential direction.

The driving mechanism 40 includes a driving member 41 and an output shaft 43. The driving member 41 is used to convert a rotational power of the motor into a linear reciprocating power of the output shaft 43, and it can be a telescopic motor. The driving member 41 is fixedly installed in the first inner space of the housing 10, and the output shaft 43 is installed with the driving member 41. One end of the output shaft 43 away from the driving member 41 is fixedly connected to the massage member 50. When the output shaft 43 reciprocatively moves under the drive of the driving member 41, the output shaft 43 drives the massage member 50 to move synchronously.

A portion of the massage member 50 is installed in the second inner space of the housing 10, and another portion of the massage member 50 extends through the openings 13 to contact the to-be-massaged member. Driven by the driving mechanism 40, the massage member 50 is movable in the second inner space 101 of the housing 10 along the longitudinal axis direction L of the housing 10, and at the same time another portion of the massage member 50 slides back and forth in the openings 13 along the guide surfaces 131.

The massage member 50 can be movably accommodated in the second inner space 101, and includes a mounting portion 51, a fixing portion 53, and a plurality of massage protrusions 55. At least one of the fixing portion 53 and the massage protrusions 55 is deformable. When the mounting portion 51 is driven to move along the first direction, the fixing portion 53 moves together with the mounting portion 51, and at least one of the fixing portion 53 and the massage protrusions 55 are forced to deformed by engagements between the massage protrusions 55 and the openings 13. In an embodiment, the fixing portion 53 is deformed to twist about the first direction. In another embodiment, both of the massage protrusions 55 and the fixing portion 53 are deformed. Alternatively, the driving mechanism 40 may be drive the mounting portion 51 to do the reciprocating motions in the first direction together with reciprocating rotations at a predefined angle. Each strip-shaped opening 13 corresponds to at least one massage protrusion 55. The mounting portion 51 is mounted on a location of the housing 10 which is away from the openings 13, one end of the mounting portion 51 is fixedly connected to the output shaft 43, and the other end of the mounting portion 51 is fixedly connected to the fixing portion 53. The fixing portion 53 is located at another location of the housing 10, which corresponds to the openings 13. The fixing portion 53 is a cylindrical structure. Multiple massage protrusions 55 protrude from a periphery of the fixing portion 53 at positions corresponding to the openings 13. The fixing portion 53 is made of soft rubber material such as silicone, and the massage protrusions 55 is formed integrally with the fixing portion 53 using the same material. The massage protrusions 55 protruding through the same opening 13 are arranged at intervals along the extending trajectory line X of the opening 13 on the outside of the housing 10. The overall length of the massage protrusions 55 in the same opening 13 is smaller than the length of the opening 13. Sides of the massage protrusions 55 contact the two guide surfaces 131, so that each massage protrusion 55 is guided by the two guide surfaces 131 to slide back and forth along the extending trajectory line X of the opening 13.

As shown in FIG. 3A and FIG. 3B, in one embodiment, the massage protrusions 55 are a plurality of hemispherical massage protrusions, and are arranged in rows and at intervals on the outer peripheral wall of the fixing portion 53 corresponding to the positions of the plurality of openings 13. A sub-group comprising three massage protrusions may be disposed in each row, namely 55a, 55b, and 55c, the massage protrusions in the sub-group are arranged along the extending trajectory line X of the opening 13 and spaced apart to each other. An arrangement line of the sub-group is set at a certain angle relative to a central axis of the fixing portion 53. That is, a deviation direction of one sub-group of the massage protrusions 55a, 55b, and 55c relative to the fixing portion 53 is consistent with the inclination direction of the opening 13, so that a top of each massage protrusion 55 protrudes outward from the opening 13 and the sides are limited by the two guide surfaces 131. Specifically, the multiple massage protrusions 55 are slidable along the extending trajectory line X within the opening 13. At least one of the massage protrusions 55a, 55b, and 55c is tilt extended from the opening 13, a tilt angle varies at different positions of the opening 13.

In an initial state, the sub-group of the massage protrusions 55 in each opening 13 may be approximately located in a middle position of the opening 13 (see FIG. 1). In this state, there are gaps between the massage protrusions 55 and the opposite ends of the opening 13 at the extending trajectory line X. When the driving mechanism 40 is switched into a working state, the output shaft 43 drives the mounting portion 51 to perform telescopic movement, thereby causing the sub-group of the multiple massage protrusions 55 to move forward in the opening 13. During this state, the massage protrusion 55c at the forefront is capable of contacting the distal end 13b of the opening 13. Alternatively, the sub-group of the massage protrusions 55 is movable backward in the opening 13, so that a massage protrusion 55a is capable of contacting the proximal end 13a of the strip-shaped opening 13. A section radius of the massage protrusion 55 gradually decreases from a side near the opening 13 to a side away from the opening 13, so that the portion of the massage protrusion 55 protruding outward from the opening 13 is in point contact with the to-be-massaged member. The massage function is achieved by the slide of the massage protrusions along the extending trajectory line X.

In one embodiment of the present disclosure, the fixing portion 53 and the massage protrusions 55 can be integrally formed, or can also be assembled and installed together by independent components. Further, during the process of multiple massage protrusions 55 tilting and sliding relative to the long axis direction L of the housing 10, part of the protrusion (55a, 55b, and 55c) can be accommodated within the strip-shaped opening 13, and the other part of the protrusion (55a, 55b, and 55c) protrudes from the strip-shaped opening 13 and contacts the to-be-massaged member. In this case, only the protrusion protruding from the strip-shaped opening 13 massages the to-be-massaged member.

In addition, to increase the comfort of the to-be-massaged member, the massage member 50 and the fixing portion 53 are made of a flexible material (such as silicone, etc.). Since the opening 13 is tilted relative to the longitudinal axis direction L of the housing 10, the massage protrusions 55 are restricted by the two inclined guide surfaces 131 while sliding along the opening 13 and is forced to deviate a certain angle relative to central axis of the housing 10. Thus, the massage protrusions 55 slide tilted relative to the housing 10. The massage protrusions 55 are deflected at a certain angle relative to the outer wall of the fixing portion, so as to be correspondingly accommodated in each opening 13, and slides obliquely relative to the housing 10 under the guidance of the two guide surfaces 131. More particularly, when the mounting portion 51 is driven to move in the first direction, at least one of the fixing portion 53 and the massage protrusion 55a, 55b, and 55c is forcibly deformed due to the engagement between the massage protrusion 55 and the opening 13. The fixing portion 53 and the massage protrusions 55 are integrally formed of a flexible material. When the massage protrusion 55 are moved to different positions, the fixing portions 53 have different degrees of deformation. At least one of the massage protrusions 55a, 55b, and 55chas a first position at which the fixing portion 53 has a first degree of deformation, a second position at which the fixing portion 53 has a second degree of deformation, a third position at which the fixing portion 53 has a third degree of deformation, the second position is located between the first position and the third position, the second degree of deformation is smaller than the first degree of deformation and the third degree of deformation.

In one embodiment of the present disclosure, the housing 10 and the massage members 50 are respectively covered with a flexible cover.

In use, the massage protrusions 55 protruding out from the openings 13 contact with the to-be-massaged member, and then the control circuit board is started by an operation on a control switch. The control circuit board 30 then enables the driving member 41, and the output shaft 43 starts to do the telescopic movement, and the output shaft 43 drives the mounting portion 51 to do the telescopic movement synchronously, thereby the massage protrusions 55 installed on the fixing portion 53 starts to move synchronously. During this process, as the fixing portion 53 and the multiple massage protrusions 55 located on its surface are all made of soft silicone material, the multiple massage protrusions 55 will twist a certain angle and deform under the pressure from the two guide surfaces 131 of the strip-shaped opening 13, and the fixing portion 53 also rotates relative to the long axis direction L of the housing 10 under the driving of multiple massage protrusions 55. Under the guidance of the opening 13, the massage protrusions 55 slides back and forth along the extending trajectory line X within the opening 13, thereby realizing the massage function on the to-be-massaged member.

### Application Example 1

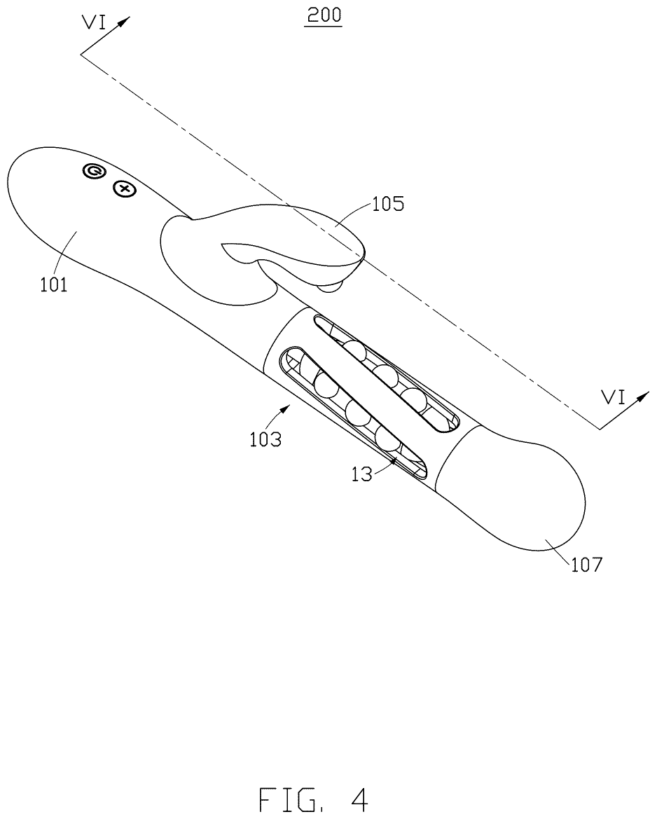

FIG. 4 is a schematic diagram of applying the disclosed massage module to a massage device in the field of adult products. In this embodiment, the same components continue to use the same component numbers as the massage module 100 shown in FIG. 1. In this application embodiment, as shown in FIG. 4 to FIG. 6, the massage device 200 mainly includes three functional modules: a handle part 101, a main massage part 103, and a secondary massage part 105. The massage device 200 is mainly used in the field of adult products, and is used to massage and stimulate private parts such as the vagina and clitoris of women, so as to bring sexual pleasure to women.

The handle part 101 adopts the above-mentioned handle portion 11 of the massage module 100, and the main massage part 103 adopts the above-mentioned massage member 50 of the massage module 100, and its structural features and functional principles can refer to the relevant description of the massage module 100, which will not be repeated here.

The end of the handle part 101 is rugby-shaped and slightly tilted downward relative to the straight line where the massage portion 50 is located. A head portion 107 is further formed at one end of the main massage part 103 away from the handle part 101. The free end of the head portion 107 is slightly tilted upward relative to the extending line of the massage device. An end surface of the head portion 107 is in an arc shape to facilitate entry into the female's vagina. A first vibration motor 70 is installed in the head portion 107, so that the head portion 107 can vibrate and bring a vibration massage effect to the vagina.

The first vibration motor 70 is coupled to a sleeve portion 73 which abuts against one end of the fixing portion 53 through a first connecting rod 71 and a waterproof chuck 72. The sleeve portion 73 detachably contacts the fixing portion 53 of the main massage part 103 and is not movable following the movement of the fixing portion 53. The secondary massage part 105 extends upward, and bends a certain curvature. An arc-shaped second connecting rod 1051 is installed in the secondary massage part 105, and a second vibration motor 80 is installed at an end of the second connecting rod 1051. In addition, a massage protrusion 1053 is formed on a lower surface of an end of the secondary massage part 105. The massage protrusion 1053 is a semicircular protrusion, which can perform point pressure on the female clitoris with the vibration of the second vibration motor 80.

In the above application example, the present disclosure arranges multiple strip-shaped openings 13 in an inclined and twisted manner, and the fixing portion 53 and the massage protrusions 55 located on it can produce torsion and deformation which can bring rotational friction to the human body's cavity and provide a better experience.

### Application Example 2

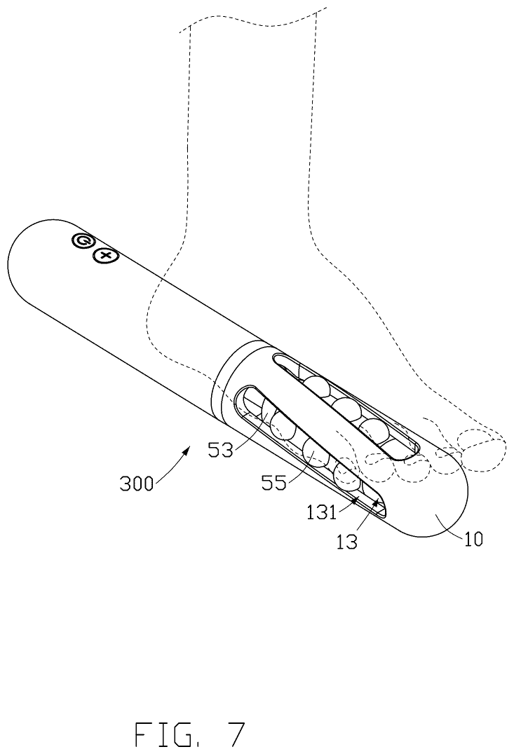

FIG. 7 is a schematic diagram of a second application example of the massage module. As shown in FIG. 7, the user can place the foot on a massage device 300 and make the acupuncture points of the sole abut against the multiple massage protrusions 55. When the massage device 300 is powered on, the massage protrusions 55 will slide forth and back along the extension direction of the openings 13. And under the guide of the guide surfaces 131, it will be slightly tilted and deviated relative to the longitudinal axis direction L of the housing 10. This movement method can disperse pressing forces on the multiple massage protrusions 55, making it less likely to be stepped on by the user's foot, and the overall movement of the fixing portion 53 is smoother.

### Application Example 3

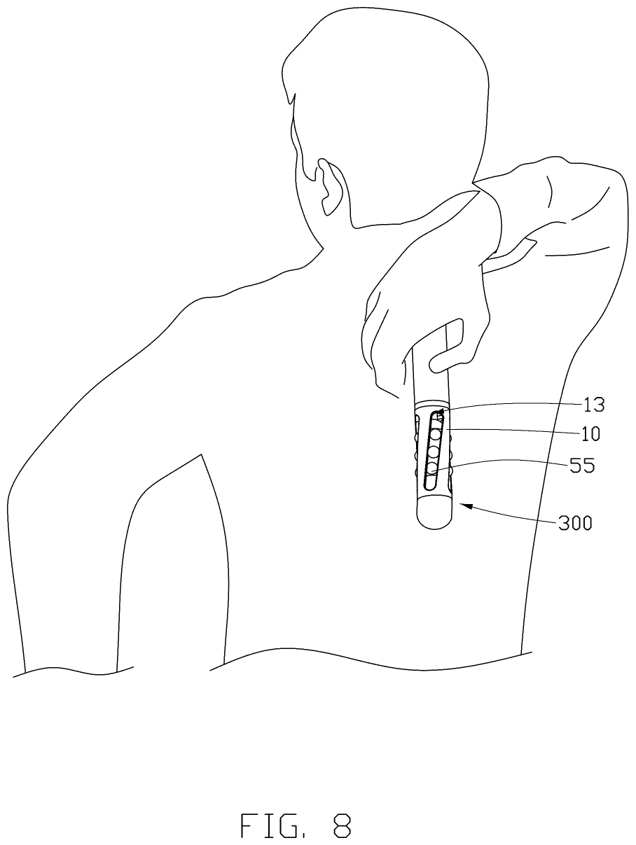

FIG. 8 is a schematic diagram of a third application example of the massage module. As shown in FIG. 8, the user can also hold the massage device 300 in his hand and place it on the back, legs, etc., and use the reciprocating sliding of multiple massage protrusions 55 in each strip-shaped opening 13 to obtain a massage effect, thereby achieving relaxation of body muscles or dredging of meridians.

### Variation Example 1

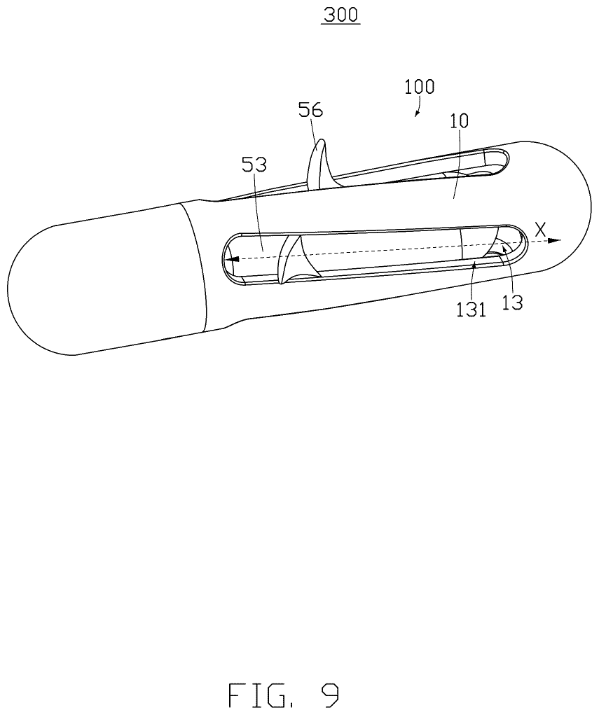

As shown in FIG. 9, as a variation of the present disclosure, the massage protrusions of the massage device 300 can be a petal-shape to replace the semicircular shape. Specifically, one end of the petal-shape of the protrusion 56 is fixedly mounted on the outer peripheral wall of the fixing portion 53, and the other end of the petal-shaped protrusion 56 protrudes outward from the strip-shaped opening 13 to massage the to-be-massaged member. Driven by the driving member, the petal-shaped protrusion 56 reciprocates along the extending trajectory line X of the strip-shaped opening 13, so that can perform a scraping massage function.

### Variation 2

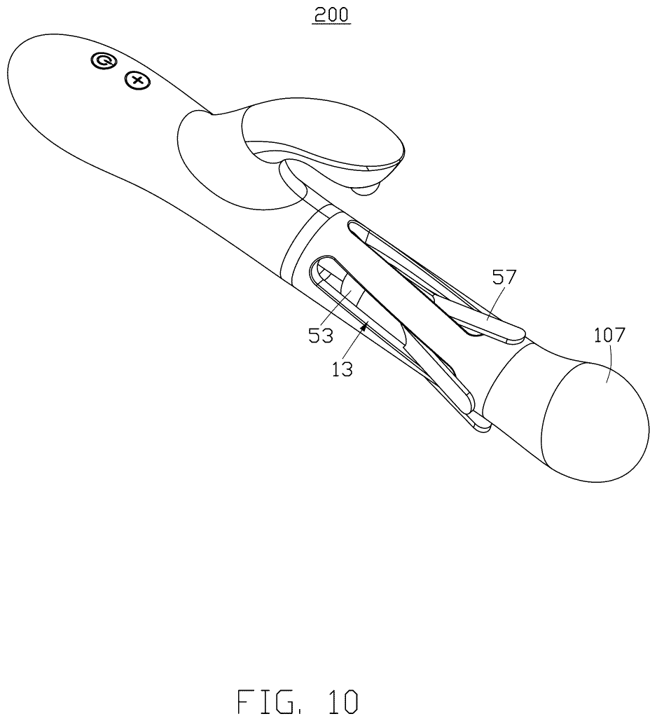

As shown in FIG. 10, as another variation of the present disclosure, the massage protrusion of the massage device 200 with the massage module 100 can be formed into a plurality of elastic pressing pieces 57 that are tilted and spread outwardly around the housing 10. The plurality of elastic pressing pieces 57 extend obliquely outward from the outer peripheral wall of the fixing portion 53 at an acute angle (preferably 10°) to the outer peripheral wall of the fixing portion 53. When the output shaft moves back and forth under the drive of the driving member, the output shaft drives the fixing portion 53 to move synchronously, so that the elastic pressing piece 57 moves forward and backward with the fixing portion 53, so as to massage and stimulate a vaginal wall. When the output shaft moves to the maximum position toward the head portion 107 of the massage device 200, free ends of the plurality of elastic pressing pieces 57 will be resisted on the outer peripheral wall of the housing near the head portion 107. Since the elastic pressing piece 57 is made of a silicone sheet, it has a certain elasticity. When the massage device 200 enters a body cavity (for example, a female's vagina), the protruding portion of the elastic pressing piece 57 will move slightly downward toward the strip-shaped opening 13 under the action of an external force of the vagina, and the angle between the elastic pressing piece 57 and the outer peripheral wall of the fixing portion 53 will become smaller to prevent damage to the vagina.

The contents not described in detail in this specification are known to those skilled in the art.

The present disclosure can be configured by freely combining the various embodiments shown above within the scope of the present disclosure described in each claim, or by appropriately modifying each embodiment or omitting a part.

The scope of the present invention is not limited to the above content, but is defined by the claims, so it can be considered that the embodiments described in this specification are only illustrative, not limiting. Therefore, all changes that do not deviate from the scope and limits of the claims, as well as contents that are equivalent to the scope and limits of the claims, are included in the scope of the claims.

The above displays and describes the basic principles, main features, and advantages of the present disclosure. Technicians in this field should understand that, the present disclosure is not limited by the above embodiments. The above embodiments and the description in the specification only illustrate the principles of the present disclosure. Without departing from the spirit and scope of the present disclosure, there will be various changes and improvements to the present disclosure, all of which fall within the scope of protection requirements. The scope of protection required by the present disclosure is defined by the attached claims and their equivalents.

1. A massage module, comprising:
a housing comprising a handle portion, and a cylindrical portion coupled to the handle portion, the cylindrical portion defining a massage area at which a massaging function is provided, at least one elongated opening defined in the massage area, and each elongated opening extending from a side of the cylindrical portion adjacent to the handle portion to a side of the cylindrical portion away from the handle portion, wherein each elongated opening is communicated with an external space of the housing;
a driving mechanism located in the housing, and comprising a motor, and
a massage member arranged in the cylindrical portion corresponding to the massage area, and driven by the motor, the massage member comprising a first portion coupled to the driving mechanism and driven by the driving mechanism; and at least one second portion coupled to the first portion, wherein the at least one second portion is extendable through the at least one elongated opening and protrudes to the external space of the housing to contact a to-be-massaged member,
wherein the first portion is driven by the motor to move along a first direction, and the at least one second portion is engaged by the first portion and telescopically moves along an inclined direction which is inclined relative to a longitudinal axis of the cylindrical portion.

2. The massage module according to claim 1, wherein,
each elongated opening has a first end and a second end,
the first end and the second end are at least partly offset when viewed from an extending direction of the cylindrical portion, and the extending direction is parallel to the longitudinal axis of the cylindrical portion, the at least one second portion protrudes out of the corresponding elongated opening and comprises multiple massage protrusions, the multiple massage protrusions are aligned along the extending direction of the corresponding elongated opening, at least one of the first portion and the multiple massage protrusions is deformable.

3. (canceled)

4. The massage module according to claim 2, wherein,
the multiple massage protrusions are formed on an outer wall of the first portion and inserted into the corresponding elongated opening,
when the first portion is driven to move along the first direction, at least one of the first portion and the multiple massage protrusions is deformed by engagements between the multiple massage protrusions and the corresponding elongated opening.

5. The massage module according to claim 4, wherein,
the first portion and the multiple massage protrusions are integrally formed by a flexible material, a deformable motion of the first portion induces a corresponding twistable displacement in the multiple massage protrusions.

6. The massage module according to claim 5, wherein,
in a case that the multiple massage protrusions are in a first position, an amount of deformation of the first portion is a first degree of deformation; in a case that the multiple massage protrusions are in a second position, the amount of the deformation of the first portion is a second degree of deformation; and in a case that the multiple massage protrusions are in a third position, the amount of deformation of the first portion is a third degree of deformation,
wherein the second position is located between the first position and the third position along the inclined direction, the second degree of deformation is smaller than each of the first degree of deformation and the third degree of deformation.

7. The massage module according to claim 2, wherein,
at least a part of the first portion is deformed to twist about the first direction parallel to the longitudinal axis of the cylindrical portion, while the first portion is driven to move along the first direction.

8. The massage module according to claim 4, wherein,
each elongated opening includes two opposite guide surfaces along the inclined direction;
in an elongated opening of the at least one elongated opening, the multiple massage protrusions contact with the two guide surfaces of the elongated opening, so as to press the at least one of the first portion and the multiple massage protrusions to deform.

9. The massage module according to claim 2, wherein,
the first portion includes a mounting portion, and a fixing portion, the mounting portion is coupled with the motor, the fixing portion is connected with the mounting portion and located in the massage area, the at least one second portion is arranged on the fixing portion, a hardness of the mounting portion is larger than a hardness of the fixing portion.

10. (canceled)

11. A massage device, comprising:
an elongated housing insertable into a vagina along an inserting direction;
a plurality of strip-shaped openings defined in the elongated housing, wherein the plurality of strip-shaped openings are arranged in parallel, at intervals, and at a same predetermined inclination angle relative to the inserting direction, the plurality of strip-shaped openings communicate to an external space of the massage device; and,
a massage member including a driven portion arranged in the elongated housing and a plurality of deformable protrusions extending out of the elongated housing through the plurality of strip-shaped openings, the plurality of deformable protrusions are coupled to the driven portion,
wherein, the plurality of deformable protrusions move along a path defined by the plurality of strip-shaped openings, while the driven portion moves along a first direction by a driver, and an extending direction of the plurality of strip-shaped openings is different from the first direction.

12. The massage device according to claim 11, wherein,
the massage member comprises a fixing portion coupled to and driven by the driven portion, the plurality of deformable protrusions are un-slidably mounted on the fixing portion, each of the plurality of deformable protrusions is extendable through a corresponding strip-shaped opening of the plurality of strip-shaped openings and extends to the external space,
the plurality of deformable protrusions is movable relative to the elongated housing along the plurality of strip-shaped openings.

13. The massage device according to claim 11, wherein,
a length direction of each of the plurality of strip-shaped openings is set at a certain inclination angle relative to a central axis of the elongated housing, the massage member is movable obliquely along the plurality of strip-shaped openings relative to the inserting direction.

14. The massage device according to claim 12, wherein,
the plurality of deformable protrusions is arranged on an outer peripheral wall of the fixing portion in rows and at intervals corresponding to positions of the plurality of strip-shaped openings,
a part of the plurality of deformable protrusions is switchable between protruding out of the elongated housing from the plurality of strip-shaped openings and being received into the elongated housing.

15. The massage device according to claim 13, wherein,
each strip-shaped opening of the plurality of strip-shaped openings includes two opposite guide surfaces, and each of the plurality of deformable protrusions is in contact with the two opposite guide surfaces of a corresponding strip-shaped opening of the plurality of strip-shaped openings;
the two opposite guide surfaces guide a corresponding deformable protrusion to slide back and forth relative to the elongated housing;
each of the plurality of deformable protrusions is deflected at a certain angle relative to a length direction of the driven portion, so as to be accommodated in the corresponding strip-shaped opening, and slides obliquely relative to the elongated housing as the two opposite guide surfaces guide the corresponding deformable protrusion.

16. The massage device according to claim 11, wherein,
the elongated housing includes a head portion tilted upward relative to the inserting direction, and
a first vibration motor is received in the head portion.

17. The massage device according to claim 11, wherein, at least two deformable protrusions of the plurality of deformable protrusions are arranged in each strip-shaped opening of the plurality of strip-shaped openings, arranged side by side and spaced apart with each other.

18. A massage device configured for massaging a massage area, the massage device comprising:
a housing;
a driving mechanism installed in the housing, the driving mechanism comprising a motor and an output shaft connected to the motor; and
a massage member coupled to the output shaft,
wherein
the massage member comprises a driven portion engaged with the output shaft, a fixing portion coupled to the driven portion, and a plurality of deformable protrusions un-slidably mounted on the fixing portion and configured to contact a to-be-massaged member, and
the fixing portion is driven by the motor to slide back and forth along a length direction of the output shaft and simultaneously makes the plurality of deformable protrusions to inclinedly move relative to the output shaft.

19. The massage device according to claim 23, wherein,
the plurality of the strip-shaped openings communicates to the outside of the housing, a plurality of massage regions are defined in the housing, wherein each massage region corresponds to a strip-shaped opening of the plurality of the strip-shaped openings, such that the massage member is adaptable to massage different parts of a human body.

20. (canceled)

21. The massage device according to claim 23, wherein, the housing comprises a straight cylindrical portion, and the straight cylindrical portion extends along the length direction of the output shaft,
the plurality of strip-shaped openings include at least three strip-shaped openings which are defined in the straight cylindrical portion, the massage member is movably installed in the straight cylindrical portion and protrudes out of the straight cylindrical portion through the at least three strip-shaped openings.

22. The massage device according to claim 21, wherein, the straight cylindrical portion has a first end and a second end opposite to the first end, each of the at least three strip-shaped openings extends from the first end to the second end along an extending direction of a corresponding one of the at least three strip-shaped openings,
and the extending direction of each of the at least three strip-shaped openings is inconsistent with the length direction of the output shaft.

23. The massage device according to claim 18, wherein the housing defines a plurality of strip-shaped openings connected to an interior of the housing, two adjacent strip-shaped openings of the plurality of strip-shaped openings are arranged in parallel and spaced apart from each other,
the plurality of deformable protrusions is disposed corresponding to the plurality of strip-shaped openings, and protrudes to an exterior of the housing via the plurality of strip-shaped openings.
